(19) United States
(12) Patent Application Publication
(10) Pub. No.: US 2011/0091330 A1
(43) Pub. Date: Apr. 21, 2011

(54) Condensate Removal Pump Controller Using Acoustic Liquid Level Sensor

(76) Inventor: Marcelo DeOliviera, Kenilworth, NJ (US)

(21) Appl. No.: 12/603,092

(22) Filed: Oct. 21, 2009

(51) Int. Cl. F04B 49/06; G01F 23/296

(52) U.S. Cl. 417/44.1; 73/290 V

(57) ABSTRACT

A pump controller is provided for removing liquid condensate from a reservoir in a condensate pump removal system which collects condensate from an air conditioning/refrigeration system. The pump controller comprises a liquid level sensor in the form of an acoustic transmitter and acoustic receiver which are used to measure the time of flight of the acoustic signal, to thereby indicate the level of the liquid and determine whether the pump should be switched on and off.

### BACKGROUND OF THE INVENTION

The present invention relates to a pump controller using an acoustic liquid level sensor for condensate removal.

The operation of air conditioning and refrigeration units, including those used to cool down computer rooms, results in condensate on the cooling coils. The condensate collects, typically in a reservoir, and the condensate needs to be pumped out to another location, sometimes with lift of 50 feet or more.

In order to control the pump operation, a standard mechanical float mechanism has been used. Condensate pump reservoirs often will develop mildew, sediments, and other foreign debris. Over time, the presence of this material can foul the mechanical float mechanism requiring cleaning, servicing, or even rendering it inoperable.

Capacitive type sensors have also been used, where the capacitor is submerged in the liquid, but residue affects the capacitive readings leading to incorrect operation and eventually failure.

### SUMMARY OF THE INVENTION

The present invention provides a pump controller for removing condensate from a liquid reservoir or tank, which controller uses an acoustic level sensor to sense the liquid level and control the pump operation.

### BRIEF DESCRIPTION OF THE DRAWINGS

FIG. 1A is a top plan perspective view of a pump controller according to an embodiment of the invention;

FIG. 1B is a top perspective view of the pump controller of FIG. 1A;

FIG. 1C is a side elevational view of the pump controller of FIG. 1A;

FIG. 1D is a front elevational view of the pump controller of FIG. 1A;

FIG. 1E is the same view as FIG. 1A, but with a cover removed;

FIG. 1F is the same view as FIG. 1B, but with the cover removed;

FIG. 1G is the same view as FIG. 1C, but with the cover removed;

FIG. 1H is the same view as FIG. 1D, but with the cover removed;

FIG. 1I is a top perspective view of the sub-module of the pump controller;

FIG. 1J is a bottom perspective view of the sub-module of FIG. 1I;

FIGS. 2A-2F together show an electric schematic of a pump control circuit according to an embodiment of the invention.

### DESCRIPTION OF THE PREFERRED EMBODIMENT

A preferred embodiment of the invention will be described, but the invention is not limited to this embodiment.

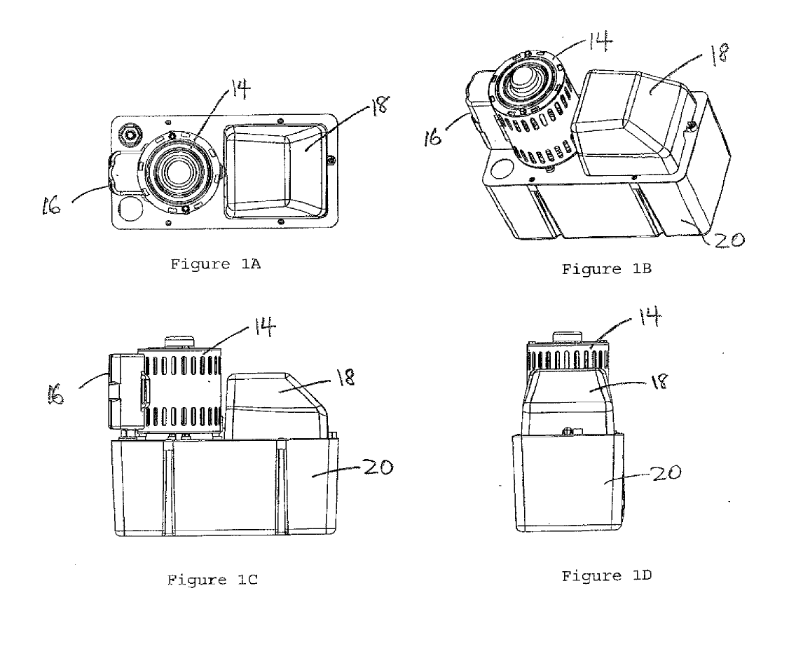

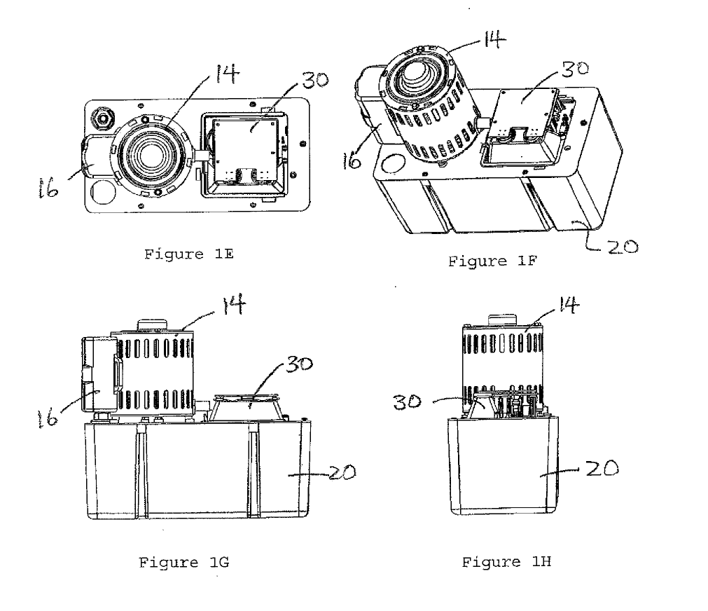

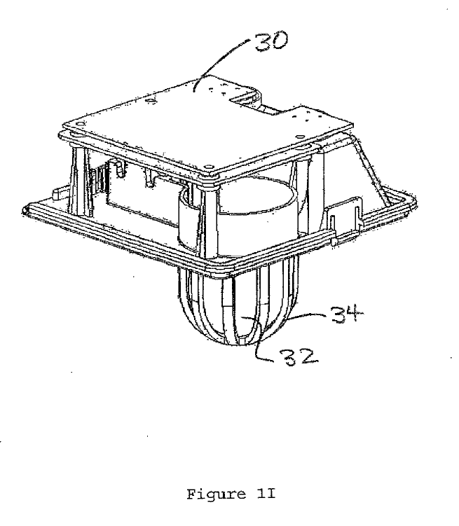

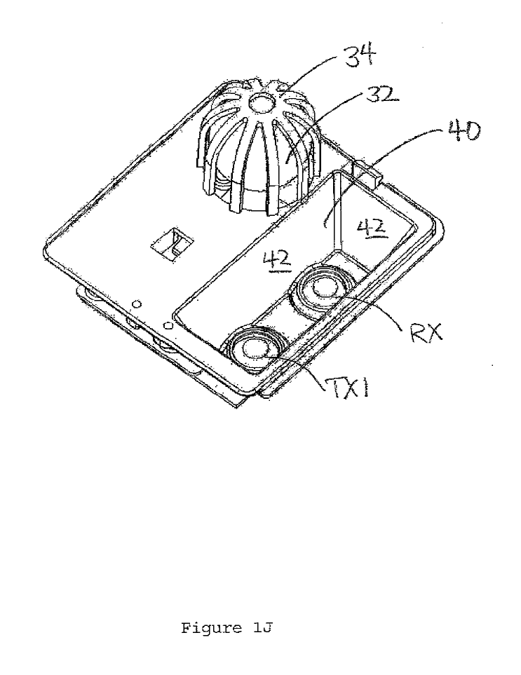

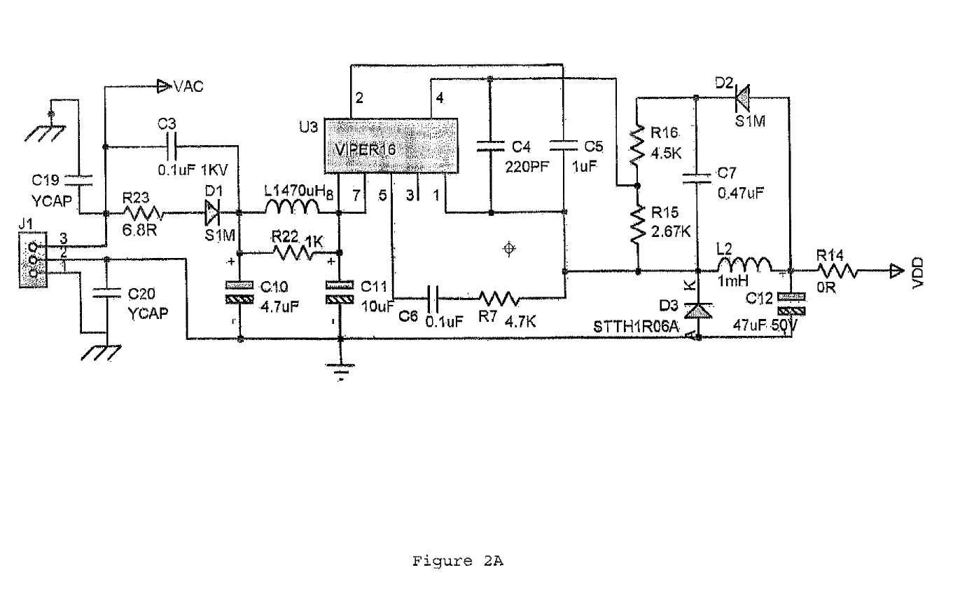

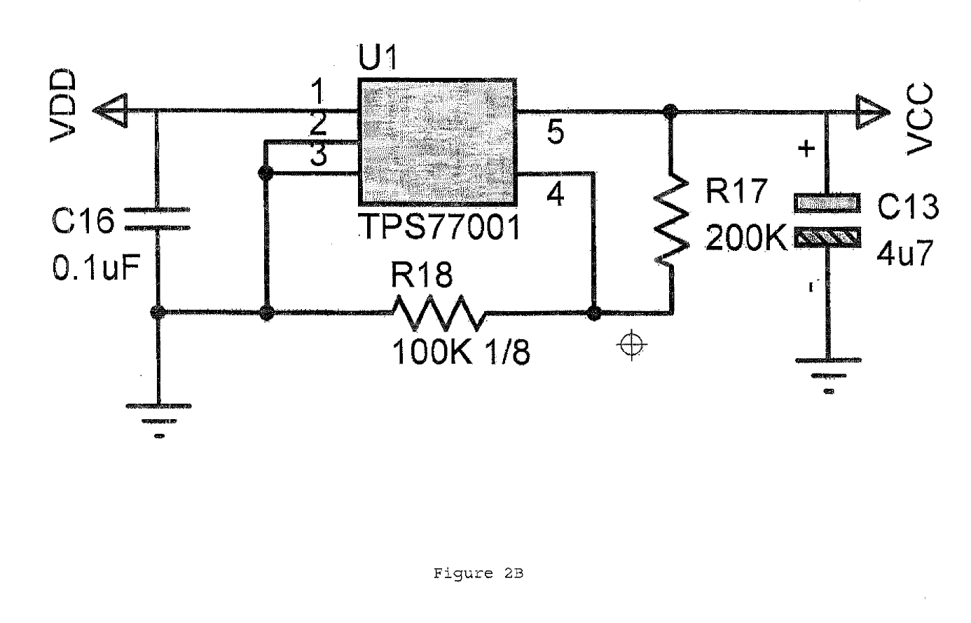

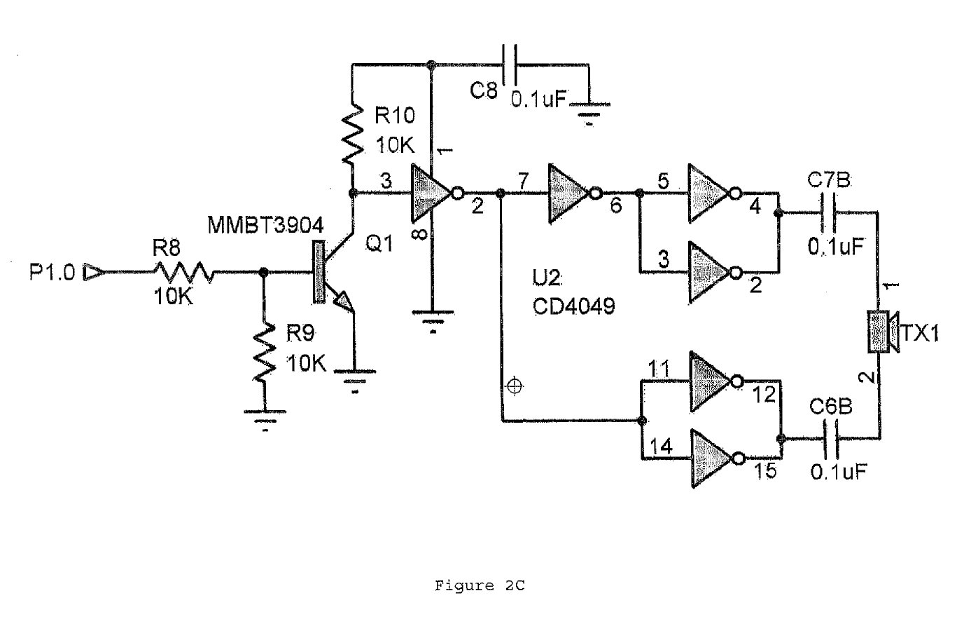

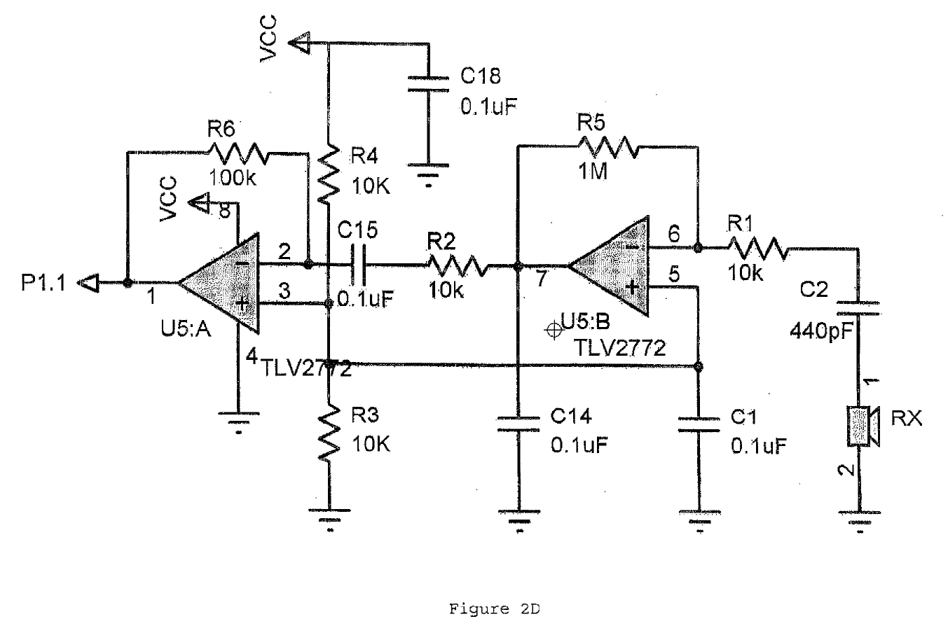

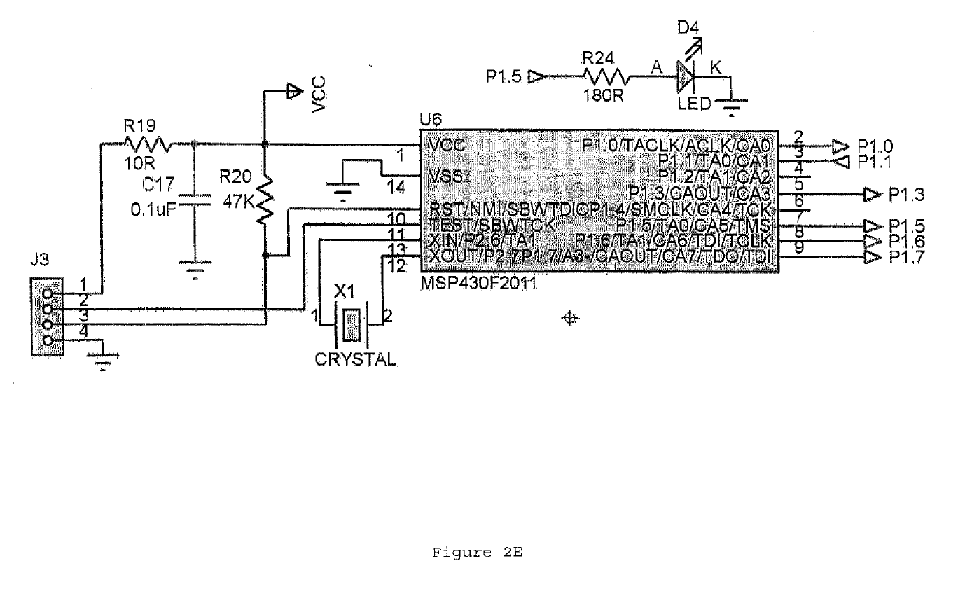

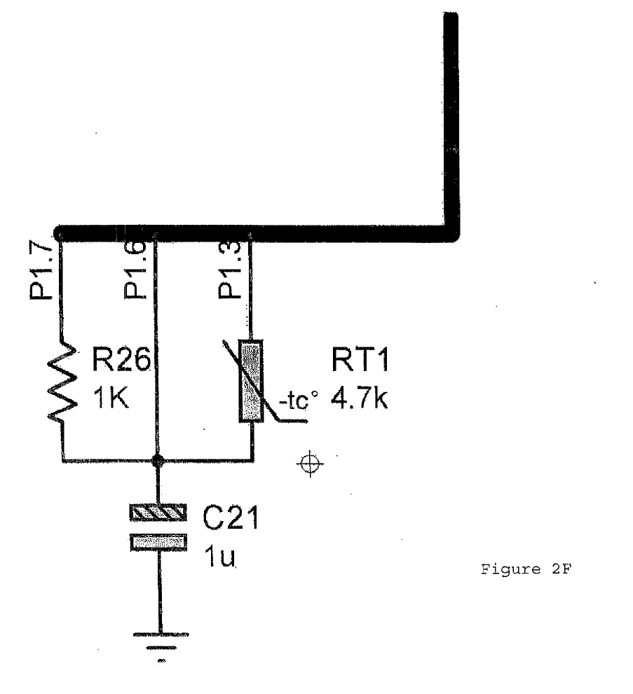

FIG. 1 shows a pump controller for removing condensate from a liquid reservoir according to the present invention.

FIGS. 1A-1J show a housing 12 for the pump controller 10 according to an embodiment of the invention.

FIG. 1A shows a motor 14 which is used to drive a pump 16. The housing 12 includes a cover 18 and a bottom portion 20. The housing 12 is adapted to sit in an AC condensate reservoir, where water collects and needs to be pumped out.

FIGS. 1E-1H show the same as FIGS. 1A-1D, respectively, but with the cover 18 removed to show the pump controller module 30. FIGS. 1I and 1J show the pump controller module 30 removed from the housing 12.

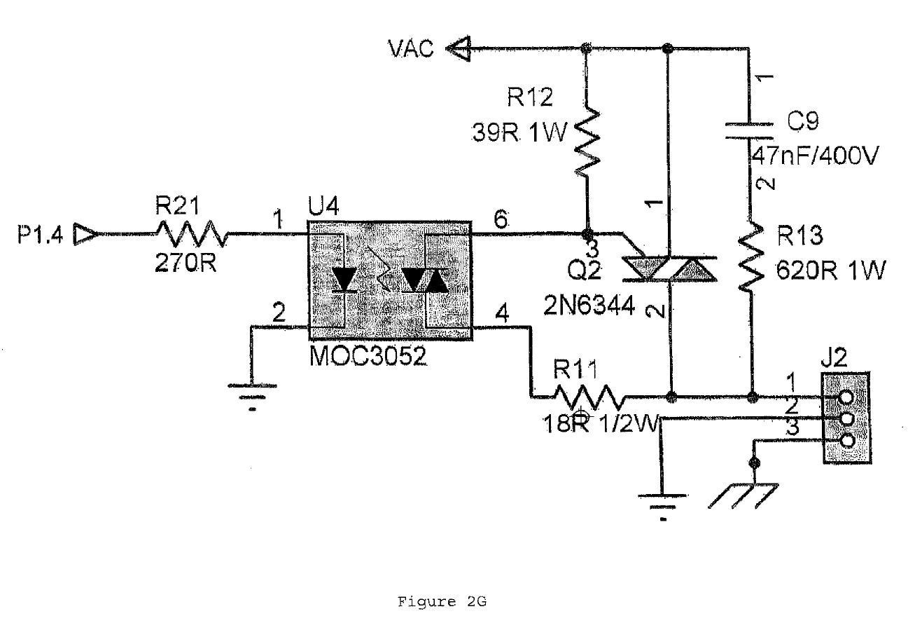

FIG. 1I shows the module 30 as having an overflow safety switch comprising a ball 32 adapted to move within a cage 34. When the housing 12 is in the reservoir and water rises, if for some reason the pump controller fails to detect the rising water level to turn on the pump (using the circuitry described below in connection with FIGS. 2A-2G), the ball will rise within the cage, closing a switch which is wired directly to the air conditioner or refrigeration unit to cut power so that the condensate level does not continue to rise, at least appreciably, to avoid an overflow condition.

As shown in FIG. 1J, the module 30 comprises an opening 40 with angled walls, at the bottom of which is an acoustic transmitter TX1 and receiver RX, which will be described below in connection with FIGS. 2A-2G. The angled walls will reduce noise from the transmitter and receiver.

FIGS. 2A-2G show an electrical schematic of the controller. FIG. 2A shows one part of the controller which comprises an AC/DC power converter adapted to receive 110 VAC power and to provide a VDD of about 9 volts DC. The circuit employs a U3-Viper 16 chip, commercially available.

FIG. 2B shows another part of the controller also comprises a voltage regulator which receives the VDD 9 VDC voltage signal and conditions and regulates it using a U1-TPST1001 chip to provide a VCC of about 5 volts DC.

FIG. 2C shows one part of the controller which includes an acoustic transmitter circuit which receives the VDD power signal and a control signal at point P1.0, supplied by a micro-controller circuit described below. The micro-controller provides the transmitter circuit with an 8 cycle burst of a 40 kHz square wave which is amplified by a bridge circuit with hex inverter gates U2-CD4049 and drives acoustic transmitter TX1. When the burst occurs, a timer feature is turned ON and the controller waits for the acoustic sound signal to return.

FIG. 2D shows the part of the controller which includes an acoustic receiver circuit comprising an acoustic receiver RX which receives the acoustic wave transmitted from the transmitter TX1 after it is echoed or reflected off the liquid in the reservoir or tank. The received signal is amplified through two amplifiers U5:A and U5:B (U5-TLV2772) and output at point P1.1 to the micro-controller. The amplification of the signal triggers a capture of a time duration. The capture count provides a measure of time indicating how long the signal transmitted from the transmitter takes to reach the liquid level, and bounce or echo back to the receiver. The time measure provides an indication of the height of the liquid level.

FIG. 2E shows the micro-controller circuit, which comprises mainly a micro-controller MSP430, processes the time signal and compares it to values indicating the high liquid level (where the pump should be turned on) and the low liquid level (where the pump should be turned off). Of course, the high and low liquid levels are appropriately spaced to prevent hunting and excessive switching on and off of the pump.

FIG. 2D shows that the controller circuit also comprises an LED D4, which is controlled through point P1.5 of the micro-controller, which indicates whether the controller is operating.

FIG. 2F shows connections for points P1.3, P1.6, and P1.7. The main controller chip provides at output point P1.4 (at pin 6) a signal to indicate pump motor ON and OFF.

FIG. 2G shows that this signal is provided to U4-MOC3052 which provides a low-voltage to high-voltage trigger to turn on the pump motor through Triac Q2-2N6344. The motor for the pump is connected to J2.

While one embodiment of the invention has been described, the invention is not limited to this embodiment, and the scope of the invention is defined by the following claims.

1. A pump controller for controlling the operation of a condensate removal pump which removed liquid condensate in an air conditioning/refrigeration system, comprising:
an acoustic transmitter/receiver for transmitting an acoustic signal towards a liquid disposed in a container from above the liquid level, for receiving the reflected acoustic signal reflected by the liquid, and for producing a signal indicating the transit time of the acoustic signal;
a comparator which compares the transit time signal to a first reference value, and a second reference value and which produces a pump-on signal when the transit time signal is below a first reference level, and produces a pump-off signal when the liquid level signal exceeds the second reference level; and
a pump in a condensate reservoir which is connected to receive the pump-on and pump-off signals, and switch on and off, respectively, in response thereto, to remove the condensate liquid in the reservoirs.

2. The pump controller of claim 1, wherein
the acoustic transmitter/receiver is mounted in a housing having walls angled downwardly away, to reduce noise.

3. The pump controller of claim 1, further
including a safety float which de-energizes an air conditioning/refrigeration condenser unit if the liquid level reaches a certain level.

4. The pump controller of claim 1, wherein
the acoustic transmitter/receiver comprises an acoustic transmitter and a separate acoustic receiver.

5. The pump controller of claim 1, wherein
the acoustic transmitter/receiver receives a multi-cycle burst of a square wave signal which is used to produce an acoustic signal.

6. The pump controller of claim 1, wherein
the pump-on and pump-off signal are connected to the pump through a triac.

7. The pump controller of claim 1, wherein
the comparator comprises a micro-controller.

8. The pump controller of claim 1, further including a pump motor.

9. The pump controller of claim 8, further including
a pump in a condensate reservoir which is connected to receive the pump-on and pump-off signals, and switch on and off, respectively, in response thereto, to remove the condensate liquid in the reservoir.

10. A method of operating a pump controller for controlling the operation of a condensate removal pump, to remove liquid in a condensate reservoir, comprising:
transmitting an acoustic wave to the top of the liquid from above the liquid;
receiving the acoustic wave reflected off the top of the liquid;
comprising the amount of time the acoustic wave took from transmission to reception with first and second reference values, representing fluid level heights;
producing a pump-on signal to turn on the condensate removal pump when the time is less than a first reference level, and producing a pump-off signal to turn off the condensate removal pump when the time exceeds a second reference level.

11. The method of claim 10, wherein
the transmitting, receiving, and comparing, are performed repetitively to repetitively measure the fluid level height.
